(19) United States
(12) Patent Application Publication
(10) Pub. No.: US 2026/0292567 A1
(43) Pub. Date: Sep. 24, 2026

(54) METHOD, APPARATUS AND COMPUTER PROGRAM

(71) Applicant: Nokia Technologies Oy, Espoo (FI)

(72) Inventors: Halit Murat GÜRSU, München (DE); Riikka Karoliina DIMNIK, Kirkkonummi (FI); Jani-Pekka KAINULAINEN, Cambridgeshire (GB); Ali KARIMIDEHKORDI, Munich (DE); Lars DALSGAARD, Oulu (FI); Tero HENTTONEN, Espoo (FI)

(21) Appl. No.: 19/471,901

(22) PCT Filed: Mar. 28, 2024
(86) PCT No.: PCT/EP2024/058410

§ 371 Date: Oct. 2, 2025

(30) Foreign Application Priority Data
Apr. 6, 2023 (GB) 2305113.9

(51) Int. Cl. H04W 24/10

(52) U.S. Cl. CPC H04W 24/10

(57) ABSTRACT

There is provided an apparatus comprising means for: receiving, from an access node, one or more termination configurations, the one or more termination configurations comprising one or more termination conditions associated with the termination of performance of one or more measurements; starting performing the one or more measurements according to a first measurement configuration; determining, based on the one or more measurements, that at least one termination condition associated with the first measurement configuration is satisfied; and terminating performance of the one or more measurements according to the first measurement configuration based on the determining.

### FIELD

The present application relates to a method, apparatus, system and computer program and in particular but not exclusively to terminating the performance of measurements.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to an aspect, there is provided an apparatus comprising means for: receiving, from an access node, one or more termination configurations, the one or more termination configurations comprising one or more termination conditions associated with the termination of performance of one or more measurements; starting performing the one or more measurements according to a first measurement configuration; determining, based on the one or more measurements, that at least one termination condition associated with the first measurement configuration is satisfied; and terminating performance of the one or more measurements according to the first measurement configuration based on the determining.

The means may be further for: receiving, from the access node, a prioritization list comprising a priority order of one or more measurement configurations for performing the one or more measurements, wherein the first measurement configuration is a measurement configuration of the one of the one or more measurement configurations having the highest priority

The means may be further for: responsive to terminating performance of the one or more measurements according to the first measurement configuration, starting performing one or more measurements according to a second measurement configuration, the second measurement configuration having a next highest priority after the first measurement configuration.

The means may be further for: determining that a termination condition associated with the second measurement configuration is satisfied and terminating performance of the one or more measurements according to the second measurement configuration.

The means may be further for: determining that a total amount of time spent performing the one or more measurements reaches or exceeds a total measurement time limit; and terminating performance of the one or more measurements according to all measurement configurations in response to determining that the total amount of time spent performing the one or more measurements reaches or exceeds the total measurement time limit.

The means may be further for: receiving, from the access node, the total measurement time limit.

The total measurement time limit may be comprised in the one or more termination configurations.

The termination condition may comprise one or more of: measurements according to a given measurement configuration have been performed for a maximum time limit; after not finding any cell in a carrier after a specified amount of time; after finding no cell in a particular carrier above a specified measurement value for a specified amount of time; the apparatus enters a particular location; the apparatus enters or is in a particular energy state; the apparatus is associated with a particular application and/or service state and the particular application and/or service state is terminated; and a camped cell of the apparatus changes.

The means may be further for: sending, to the access node, a message comprising information indicating that measurement results based on the one or more measurements are available; receiving, from the access node, a request for the measurement results; and sending, to the access node, the measurement results.

According to an aspect, there is provided an apparatus comprising means for: sending, to a user equipment, one or more termination configurations, the one or more termination configurations comprising one or more termination conditions associated with the termination of performance of one or more measurements at the user equipment.

The means may be further for: sending, to the user equipment, a prioritization list comprising a priority order of one or more measurement configurations for performing the one or more measurements.

The means may be further for: sending, to the user equipment, a total measurement time limit, wherein the one or more measurements are to be terminated according to all measurement configurations in response to the total amount of time spent by the user equipment performing the one or more measurements reaches or exceeds the total measurement time limit.

The total measurement time limit may be comprised in the one or more termination configurations.

The termination condition may comprise one or more of: measurements according to a given measurement configuration have been performed for a maximum time limit; after not finding any cell in a carrier after a specified amount of time; after finding no cell in a particular carrier above a specified measurement value for a specified amount of time; the user equipment enters a particular location; the user equipment enters or is in a particular energy state; the user equipment is associated with a particular application and/or service state and the particular application and/or service state is terminated; and a camped cell of the user equipment changes.

The means may be further for: receiving, from the user equipment, a message comprising information indicating that measurement results based on the one or more measurements are available; sending, to the user equipment, a request for the measurement results; and receiving, from the user equipment, the measurement results.

According to an aspect, there is provided an apparatus comprising at least one processor and at least one memory storing instructions that, when executed by the at least one processor, cause the apparatus at least to: receive, from an access node, one or more termination configurations, the one or more termination configurations comprising one or more termination conditions associated with the termination of performance of one or more measurements; start performing the one or more measurements according to a first measurement configuration; determine, based on the one or more measurements, that at least one termination condition associated with the first measurement configuration is satisfied; and terminate performance of the one or more measurements according to the first measurement configuration based on the determining.

The at least one processor may cause to apparatus to further: receive, from the access node, a prioritization list comprising a priority order of one or more measurement configurations for performing the one or more measurements, wherein the first measurement configuration is a measurement configuration of the one of the one or more measurement configurations having the highest priority The at least one processor may cause to apparatus to further, responsive to terminating performance of the one or more measurements according to the first measurement configuration, start performing one or more measurements according to a second measurement configuration, the second measurement configuration having a next highest priority after the first measurement configuration.

The at least one processor may cause to apparatus to further: determine that a termination condition associated with the second measurement configuration is satisfied and terminate performance of the one or more measurements according to the second measurement configuration.

The at least one processor may cause to apparatus to further: determine that a total amount of time spent performing the one or more measurements reaches or exceeds a total measurement time limit; and terminate performance of the one or more measurements according to all measurement configurations in response to determining that the total amount of time spent performing the one or more measurements reaches or exceeds the total measurement time limit.

The at least one processor may cause to apparatus to further: receive, from the access node, the total measurement time limit.

The total measurement time limit may be comprised in the one or more termination configurations.

The termination condition may comprise one or more of: measurements according to a given measurement configuration have been performed for a maximum time limit; after not finding any cell in a carrier after a specified amount of time; after finding no cell in a particular carrier above a specified measurement value for a specified amount of time; the apparatus enters a particular location; the apparatus enters or is in a particular energy state; the apparatus is associated with a particular application and/or service state and the particular application and/or service state is terminated; and a camped cell of the apparatus changes.

The at least one processor may cause to apparatus to further: send, to the access node, a message comprising information indicating that measurement results based on the one or more measurements are available; receive, from the access node, a request for the measurement results; and send, to the access node, the measurement results.

According to an aspect, there is provided an apparatus comprising at least one processor and at least one memory storing instructions that, when executed by the at least one processor, cause the apparatus at least to: send, to a user equipment, one or more termination configurations, the one or more termination configurations comprising one or more termination conditions associated with the termination of performance of one or more measurements at the user equipment.

The at least one processor may cause to apparatus to further: send, to the user equipment, a prioritization list comprising a priority order of one or more measurement configurations for performing the one or more measurements.

The at least one processor may cause to apparatus to further: send, to the user equipment, a total measurement time limit, wherein the one or more measurements are to be terminated according to all measurement configurations in response to the total amount of time spent by the user equipment performing the one or more measurements reaches or exceeds the total measurement time limit.

The total measurement time limit may be comprised in the one or more termination configurations.

The termination condition may comprise one or more of: measurements according to a given measurement configuration have been performed for a maximum time limit; after not finding any cell in a carrier after a specified amount of time; after finding no cell in a particular carrier above a specified measurement value for a specified amount of time; the user equipment enters a particular location; the user equipment enters or is in a particular energy state; the user equipment is associated with a particular application and/or service state and the particular application and/or service state is terminated; and a camped cell of the user equipment changes.

The at least one processor may cause to apparatus to further: receive, from the user equipment, a message comprising information indicating that measurement results based on the one or more measurements are available; send, to the user equipment, a request for the measurement results; and receive, from the user equipment, the measurement results.

According to an aspect, there is provided a method comprising: receiving, from an access node, one or more termination configurations, the one or more termination configurations comprising one or more termination conditions associated with the termination of performance of one or more measurements; starting performing the one or more measurements according to a first measurement configuration; determining, based on the one or more measurements, that at least one termination condition associated with the first measurement configuration is satisfied; and terminating performance of the one or more measurements according to the first measurement configuration based on the determining.

The method may further comprise: receiving, from the access node, a prioritization list comprising a priority order of one or more measurement configurations for performing the one or more measurements, wherein the first measurement configuration is a measurement configuration of the one of the one or more measurement configurations having the highest priority

The method may further comprise: responsive to terminating performance of the one or more measurements according to the first measurement configuration, starting performing one or more measurements according to a second measurement configuration, the second measurement configuration having a next highest priority after the first measurement configuration.

The method may further comprise: determining that a termination condition associated with the second measurement configuration is satisfied and terminating performance of the one or more measurements according to the second measurement configuration.

The method may further comprise: determining that a total amount of time spent performing the one or more measurements reaches or exceeds a total measurement time limit; and terminating performance of the one or more measurements according to all measurement configurations in response to determining that the total amount of time spent performing the one or more measurements reaches or exceeds the total measurement time limit.

The method may further comprise: receiving, from the access node, the total measurement time limit.

The total measurement time limit may be comprised in the one or more termination configurations.

The termination condition may comprise one or more of: measurements according to a given measurement configuration have been performed for a maximum time limit; after not finding any cell in a carrier after a specified amount of time; after finding no cell in a particular carrier above a specified measurement value for a specified amount of time; the apparatus enters a particular location; the apparatus enters or is in a particular energy state; the apparatus is associated with a particular application and/or service state and the particular application and/or service state is terminated; and a camped cell of the apparatus changes.

The method may further comprise: sending, to the access node, a message comprising information indicating that measurement results based on the one or more measurements are available; receiving, from the access node, a request for the measurement results; and sending, to the access node, the measurement results.

According to an aspect, there is provided a method comprising: sending, to a user equipment, one or more termination configurations, the one or more termination configurations comprising one or more termination conditions associated with the termination of performance of one or more measurements at the user equipment.

The method may further comprise: sending, to the user equipment, a prioritization list comprising a priority order of one or more measurement configurations for performing the one or more measurements.

The method may further comprise: sending, to the user equipment, a total measurement time limit, wherein the one or more measurements are to be terminated according to all measurement configurations in response to the total amount of time spent by the user equipment performing the one or more measurements reaches or exceeds the total measurement time limit.

The total measurement time limit may be comprised in the one or more termination configurations.

The termination condition may comprise one or more of: measurements according to a given measurement configuration have been performed for a maximum time limit; after not finding any cell in a carrier after a specified amount of time; after finding no cell in a particular carrier above a specified measurement value for a specified amount of time; the user equipment enters a particular location; the user equipment enters or is in a particular energy state; the user equipment is associated with a particular application and/or service state and the particular application and/or service state is terminated; and a camped cell of the user equipment changes.

The method may further comprise: receiving, from the user equipment, a message comprising information indicating that measurement results based on the one or more measurements are available; sending, to the user equipment, a request for the measurement results; and receiving, from the user equipment, the measurement results.

According to an aspect, there is provided a computer readable medium comprising instructions which, when executed by an apparatus, cause the apparatus to perform at least the following: receiving, from an access node, one or more termination configurations, the one or more termination configurations comprising one or more termination conditions associated with the termination of performance of one or more measurements; starting performing the one or more measurements according to a first measurement configuration; determining, based on the one or more measurements, that at least one termination condition associated with the first measurement configuration is satisfied; and terminating performance of the one or more measurements according to the first measurement configuration based on the determining.

The instructions, when executed by the apparatus, may cause the apparatus for further perform: receiving, from the access node, a prioritization list comprising a priority order of one or more measurement configurations for performing the one or more measurements, wherein the first measurement configuration is a measurement configuration of the one of the one or more measurement configurations having the highest priority

The instructions, when executed by the apparatus, may cause the apparatus for further perform: responsive to terminating performance of the one or more measurements according to the first measurement configuration, starting performing one or more measurements according to a second measurement configuration, the second measurement configuration having a next highest priority after the first measurement configuration.

The instructions, when executed by the apparatus, may cause the apparatus for further perform: determining that a termination condition associated with the second measurement configuration is satisfied and terminating performance of the one or more measurements according to the second measurement configuration.

The instructions, when executed by the apparatus, may cause the apparatus for further perform: determining that a total amount of time spent performing the one or more measurements reaches or exceeds a total measurement time limit; and terminating performance of the one or more measurements according to all measurement configurations in response to determining that the total amount of time spent performing the one or more measurements reaches or exceeds the total measurement time limit.

The instructions, when executed by the apparatus, may cause the apparatus for further perform: receiving, from the access node, the total measurement time limit.

The total measurement time limit may be comprised in the one or more termination configurations.

The termination condition may comprise one or more of: measurements according to a given measurement configuration have been performed for a maximum time limit; after not finding any cell in a carrier after a specified amount of time; after finding no cell in a particular carrier above a specified measurement value for a specified amount of time; the apparatus enters a particular location; the apparatus enters or is in a particular energy state; the apparatus is associated with a particular application and/or service state and the particular application and/or service state is terminated; and a camped cell of the apparatus changes.

The instructions, when executed by the apparatus, may cause the apparatus for further perform: sending, to the access node, a message comprising information indicating that measurement results based on the one or more measurements are available; receiving, from the access node, a request for the measurement results; and sending, to the access node, the measurement results.

According to an aspect, there is provided a computer readable medium comprising instructions which, when executed by an apparatus, cause the apparatus to perform at least the following: sending, to a user equipment, one or more termination configurations, the one or more termination configurations comprising one or more termination conditions associated with the termination of performance of one or more measurements at the user equipment.

The instructions, when executed by the apparatus, may cause the apparatus for further perform: sending, to the user equipment, a prioritization list comprising a priority order of one or more measurement configurations for performing the one or more measurements.

The instructions, when executed by the apparatus, may cause the apparatus for further perform: sending, to the user equipment, a total measurement time limit, wherein the one or more measurements are to be terminated according to all measurement configurations in response to the total amount of time spent by the user equipment performing the one or more measurements reaches or exceeds the total measurement time limit.

The total measurement time limit may be comprised in the one or more termination configurations.

The termination condition may comprise one or more of: measurements according to a given measurement configuration have been performed for a maximum time limit; after not finding any cell in a carrier after a specified amount of time; after finding no cell in a particular carrier above a specified measurement value for a specified amount of time; the user equipment enters a particular location; the user equipment enters or is in a particular energy state; the user equipment is associated with a particular application and/or service state and the particular application and/or service state is terminated; and a camped cell of the user equipment changes.

The instructions, when executed by the apparatus, may cause the apparatus for further perform: receiving, from the user equipment, a message comprising information indicating that measurement results based on the one or more measurements are available; sending, to the user equipment, a request for the measurement results; and receiving, from the user equipment, the measurement results.

According to an aspect, there is provided a non-transitory computer readable medium comprising program instructions that, when executed by an apparatus, cause the apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a representation of a network system according to some example embodiments;

FIG. 2 shows a representation of a control apparatus according to some example embodiments;

FIG. 3 shows a representation of an apparatus according to some example embodiments;

FIG. 4 shows an example of early measurement reporting behaviour for a user equipment in RRC idle mode;

FIG. 5 shows an example of early measurement reporting behaviour for a user equipment

FIG. 6 shows methods according to some examples; and

FIG. 7 shows a signalling exchange according to some examples.

### DETAILED DESCRIPTION

A non-exhaustive list of some abbreviations used throughout the present disclosure is provided below for reference:
5QI 5G QOS Indicator
CA Carrier Aggregation
CSI Channel state information
DC Dual connectivity
DL Downlink
DU Distributed unit
DRX Discontinuous Reception
eEMR Release 18 and above enhancements on early measurement reporting
eMBB Enhanced mobile broadband
EMR Early measurement reporting
FR1 Frequency range 1
FR1/FR2 Frequency range 1/2
FR2 Frequency range 2
L1 Layer 1 (physical layer)
L3 Layer 3 (network layer)
MR Multi-Radio
Multi-RX UE that is capable of performing RX/TX on multiple cells. May be dual active protocol stack (DAPS) or different to DAPS
NR New radio
Pcell Primary Cell
PDCCH Physical Downlink Control Channel
PRACH Physical Random Access Channel
PSCell Primary cell of a SCG
PUCCH Physical Uplink Control Channel
PUSCH Physical Upling Shared Channel
RF Radio Frequency or Radio Front-end
RLC Radio link control (sublayer of Layer 2 in RAN)
RRC Radio resource control
RS Reference Signal
RX/TX Receiver/Transmitter
Scell Secondary Cell
SPCell Special Cell/Primary cell of a master or secondary cell group
SCG Secondary cell group
SIB System Information Block
SN Secondary node
UE User equipment
UL Uplink
URLLC Ultra-Reliable and Low Latency Communications

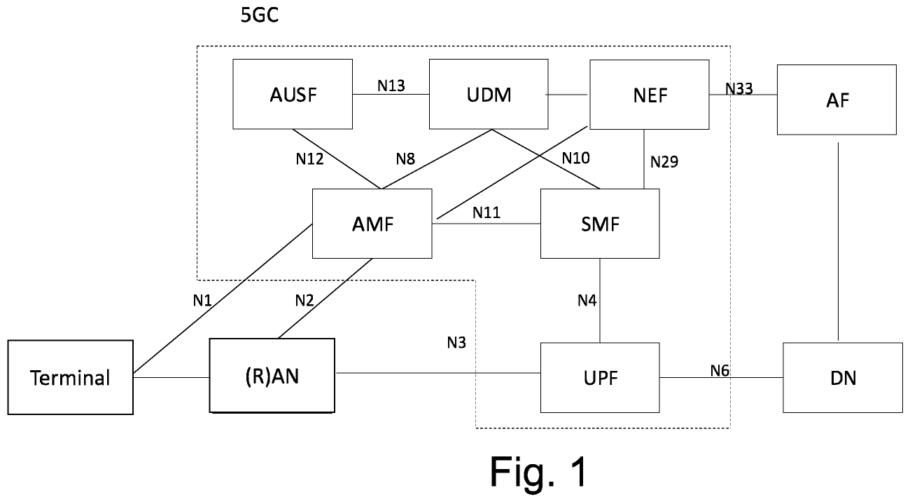

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may be comprised by a terminal or user equipment (UE), a 5G radio access network (5GRAN) or next generation radio access network (NG-RAN), a 5G core network (5GC), one or more application function (AF) and one or more data networks (DN).

The 5G-RAN may comprise one or more gNodeB (GNB) or one or more gNodeB (GNB) distributed unit functions connected to one or more gNodeB (GNB) centralized unit functions. The 5GC may comprise the following entities: Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); and Session Management Function (SMF). FIG. 1 also shows the various interfaces (N1, N2 etc.) that may be implemented between the various elements of the system.

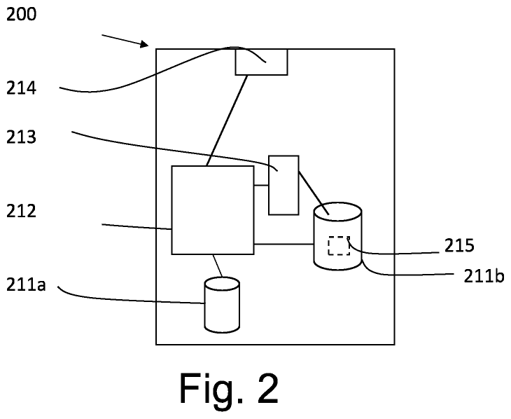

FIG. 2 illustrates an example of a control apparatus 200 for controlling a function of the 5GRAN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GC. In some embodiments, each function of the 5GRAN or the 5GC comprises a control apparatus 200. In alternative embodiments, two or more functions of the 5GRAN or the 5GC may share a control apparatus.

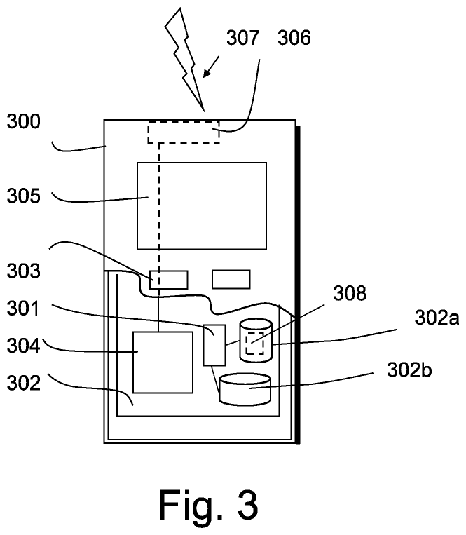

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as key pad 305, touch sensitive screen or pad, combinations thereof or the like. Optionally one or more of a display, a speaker and a microphone may be provided depending on the type of the device.

In third generation partnership project (3GPP) release 16, an EMR (Early Measurement Reporting) feature was introduced to enable faster setup or reconfiguration, particularly for carrier aggregation (CA)/dual connectivity (DC). The EMR feature may enable the UE to perform frequency measurement for availability of SCells when the UE is in a radio resource control (RRC) idle state or an RRC inactive state. While performing a transition to RRC connected state from RRC idle state or RRC inactive state, the UE may transmit a generated early measurement report to a base station associated with a primary cell (PCell) to reduce delay in setting up DC or CA.

In some EMR schemes, the UE may be equipped with a timer (e.g. T331) and given the option to measure specific frequencies. The camped cell may send, to the UE, signalling, such as system information (e.g. SIB2 and SIB11), which provides information about whether the cell is interested in EUTRA and/or NR measurements, and which cells and carrier frequencies the UE should measure.

While in idle or inactive state, the UE may perform the measurements. If an RRC setup request is triggered while the timer is still running, the UE may report its measurement availability in an RRC message (e.g. RRCSetupComplete message). If the UE is in the inactive state, it may send the measurements to the network in an RRC message (e.g. RRCResumeComplete message). The network may then request the measurements, based on the reported measurement availability. The UE may provide the measurements to the network, for example in response to receiving the request from the network.

However, it is important to note that the measurements may become invalid after the timer expires, and as such the network may be unable to use them if the measurements are provided after expiry of the timer.

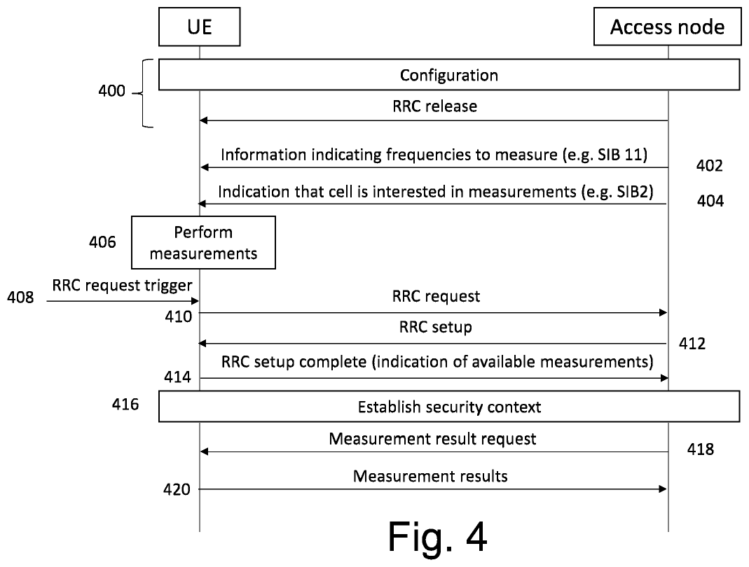

FIG. 4 shows an example of EMR behavior for a UE in RRC idle mode.

At step 400, the UE may be configured with information for performing EMR while in RRC connected mode, and subsequently release the RRC connection. The information may include a timer (e.g. T331) and optional frequencies to measure for EMR.

At step 402, the UE may receive information, such as SIB 11, from the camped cell to determine which cells and which carrier frequency to measure for early measurements.

At step 404, the UE may receive information, such as SIB 2, from the camped cell to determine if the camped cell is interested in measurements. The measurements may be for New Radio (NR) and/or Evolved Universal Mobile Telecommunications System (UMTS) Terrestrial Radio Access (EUTRA).

Steps 402 and 404 may be performed each time after the UE reselects to a new cell. The UE may update its EMR configuration based on the received information. That is to say, when the UE reselects to a new cell, the UE may receive information (e.g. SIB11 and/or SIB2) and update its measurement configuration accordingly.

At step 406, the UE may perform measurements based on the information received in steps 400-404.

At step 408, a UE procedure may trigger an RRC request to be sent to the network. The trigger may be any suitable trigger, such as but not limited to as an answer to a paging message, after initating a control message, or after initiating a mobile originating data communication. At step 410, the UE may send an RRC Request message to the network. At step 412, the network may respond with an RRCSetup message.

If this procedure is triggered while the timer indicated in step 400 is active, then UE may follow the following procedure. Otherwise the UE may not report any already obtained measurements during the connection setup procedure.

At step 414, the UE may send an RRCSetupComplete message to the network. The RRCSetupComplete message may comprise information indicating the availability of the measurements.

At step 416, security keys may be exchanged between the UE and the network to establish a security context.

At step 418, the network sends, to the UE, an Information Request message requesting that the measurement results are provided.

At step 420, the UE sends, to the network, a response message containing the requested measurement results.

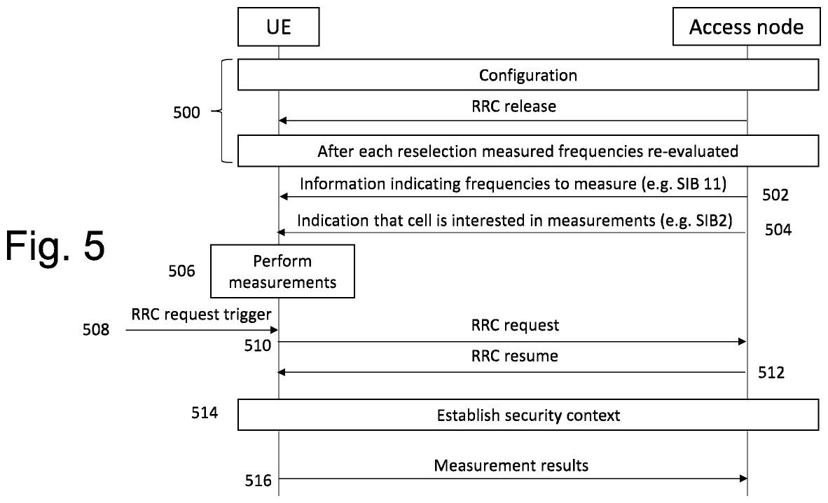

FIG. 5 shows an example of EMR behavior for a UE in RRC inactive mode.

At step 500, the UE may be configured with information for performing EMR. The information may include a timer (e.g. T331) and optional frequencies to measure for EMR.

At step 502, the UE may receive information, such as SIB 11, from the camped cell to determine which cells and which carrier frequency to measure for early measurements.

At step 504, the UE may receive information, such as SIB 2, from the camped cell to determine if the camped cell is interested in measurements. The measurements may be for New Radio (NR) and/or Evolved Universal Mobile Telecommunications System (UMTS) Terrestrial Radio Access (EUTRA).

At step 506, the UE may perform measurements based on the information received in steps 500-504.

At step 508, a UE procedure may trigger an RRC request to be sent to the network. The trigger may be any suitable trigger, such as but not limited to an answer to a paging message, after initating a control message, or after initiating a mobile originating data communication.

### At Step 510, the Ue May Send an Rrc Request Message to the Network.

At step 512, the network may respond with an RRCResume message. The RRCResume message may comprise a request for measurements.

If this procedure is triggered while the timer indicated in step 500 is active, then UE may follow the following procedure. Otherwise the UE may not report any already obtained measurements during the connection setup procedure.

At step 514, security keys may be exchanged between the UE and the network to establish a security context.

At step 516, the UE sends, to the network, a RRCResumeComplete message containing the requested measurement results.

In both examples of FIG. 4 and FIG. 5, the UE indicating the available measurements during the timer proposes a limited use-case for measurement. As such the measurements may not be used or considered by the network after timer is expired.

However, to prepare and establish a Primary Secondary cell group cell (PScell)/Secondary Cell (Scell) in dual connectivity (DC) carrier aggregation (CA) (DCCA), the network may need to wait for the EMR measurements, which as explained above are available after complete connection establishment (and exchanging security keys) that includes several message exchange between the UE and network plus processing time, all of which may delay DCCA setup. If the delay is too long, then the measurements may no longer be valid, as the timer may have expired.

In some implementations, the network or an element of the network (e.g. the RAN) may determine one or more measurement validity configurations based on the EMR settings. The validity configurations may identify one or more of: the list of cells, list of bands, list of carriers, measurement periodicity, SSB period of the cells, signal strength and/or other characteristics that need to be met to obtain a valid EMR measurement. The validity configurations may therefore be understood as being conditions to be fulfilled to obtain valid EMR measurements.

Each validity configuration may be associated with a validity identifier. The validity configurations/identifiers may be conveyed to the UE, and the UE may start performing measurements specified by the validity configurations. Based on the validity configurations, the UE may perform measurements and communicate the results to the network through signalling, such as RRC connection setup complete message. These signalling may indicate one or more of: available measurements, valid measurements, the age of the measurements, and may be specific to the cell/carrier/bands configured in the validity configuration. The network may then utilize this information to identify the appropriate SCell or PSCell for the UE to initiate the SCell and PSCell addition procedure.

However, a drawback with such implementations is that they may cause the UE to perform additional measurements to enhance the DCCA setup procedure. Such implementations and other schemes may have the disadvantage of forcing extra energy consumption for the UE, particularly when UE is not under the coverage of any cell capable of providing dual connectivity or carrier aggregation.

That is to say, in some cases configuring the UE to perform EMR measurements (and in particular configuring the UE to perform additional EMR measurements) may cause extra energy consumption at the UE side without any benefit. Some examples of the present application may limit the measurements UE is configured to perform, thereby reducing unnecessary UE energy consumption.

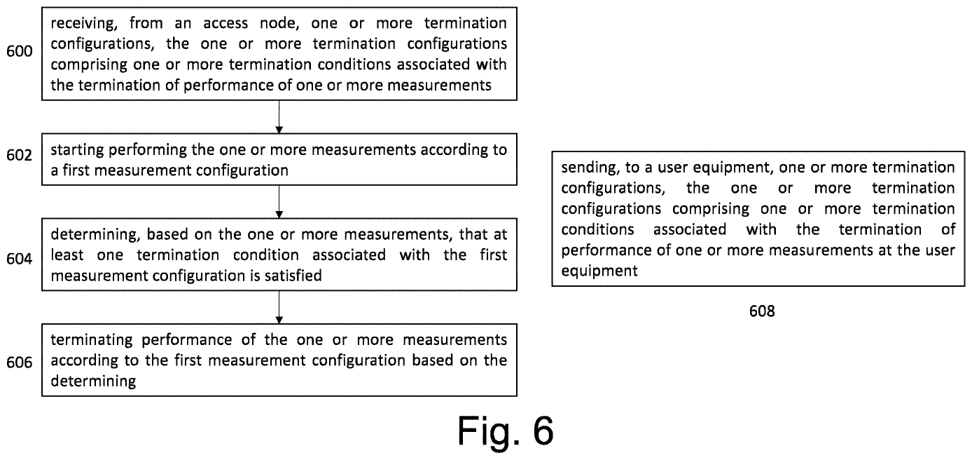

Reference is made to FIG. 6, which shows methods according to some examples.

At 600, a method comprises receiving, from an access node, one or more termination configurations, the one or more termination configurations comprising one or more termination conditions associated with the termination of performance of one or more measurements.

At 602, the method comprises starting performing the one or more measurements according to a first measurement configuration.

At 604, the method comprises determining, based on the one or more measurements, that at least one termination condition associated with the first measurement configuration is satisfied.

At 606, the method comprises terminating performance of the one or more measurements according to the first measurement configuration based on the determining.

Steps 600-606 may in some examples be performed by an apparatus such as a User Equipment (UE).

At 608, a method comprises sending, to a user equipment, one or more termination configurations, the one or more termination configurations comprising one or more termination conditions associated with the termination of performance of one or more measurements at the user equipment.

Step 608 may in some examples be performed by a network node, such as an access node (e.g. gNB).

In some examples, the network may provide the UE with information indicating when or what conditions to terminate EMR measurements. This information, referred to herein as a termination configuration, may one or more termination conditions for a measurement configuration (for example how long the UE should perform the measurements according to the measurement configuration, and/or how long the whole measurement process should last). In some examples, the network may provide the UE with more than one termination configuration. The UE may then perform measurements based on the measurement configuration(s) and the termination configuration(s).

Based on the termination condition(s) the UE may stop performing the measurements for a given configuration. Example termination conditions include, but are not limited to:
measurements on a given resource have been performed for a maximum time limit;
after not finding any cell in a carrier after a specified amount of time;
after finding no cell in a particular carrier above a specified RSRP value for a specified amount of time.
the UE enters a particular location (for example, the UE moves to a specific location defined by, for example, tracking area (TA) or global positioning system co-ordinates);
the UE enters or is in a particular energy state, for example a low battery state;
the apparatus is associated with a particular application and/or service state and the particular application and/or service state is terminated; and
the camped cell of the UE changes; and
an overall time limit for how long the measurement process should last.

The energy state of the UE may refer to the level of battery of a UE operating with a battery. The energy state may indicate how long can the UE can operate without charging its battery. This parameter may be related to the performance of measurements, as measurements being continuously performed at the UE may be a continuous drain of UE battery.

In some examples, a particular application or service might be initiated at the UE side. The initiation of an application or service might require higher throughput then normal, which the UE may need DCCA setup for. Unless a particular application or service is started, the UE may refrain from performing measurements. When the particular service or application is terminated, the UE may terminate the measurements.

In some examples, information associated with the camped cell may indicate the cell that UE will connect to. For the carrier aggregation operation and dual connectivity operation the primary cell may control which cell will be selected for both of these operations. The camped cell of the UE may become the primary cell of the UE once UE transitions to RRC Connected state. For this reason the camped cell information of the UE may indicate which cells and frequencies are relevant for the UE, as this may be limited with the cells that can be controlled by the primary cell or the camped cell. In some examples, if the camped cell changes, then the UE may terminate performing measurements relating to a previous camped cell.

It should be understood that in some examples, different termination conditions other than these examples may be used. Furthermore, while some examples may relate to termination of EMR measurements, in other examples the same principles may apply to measurements other than EMR measurements.

Thus the UE may be directed to stop performing measurements based on the termination configuration(s), thereby saving energy. The termination configuration(s) may indicate conditions that are considered unlikely that any viable measurements will be found. For example, if a UE is initially configured to perform measurements for an initial timer duration of 10 seconds, but is configured with a termination configuration to stop performing measurements after 5 seconds of not finding any cell in a carrier, then if no cell is found after 5 seconds then the UE may stop performing measurements, thereby saving energy for the remaining 5 seconds of the initial timer. However if a cell is found after 2 seconds, the UE may continue to perform measurements for the remaining 8 seconds of the initial timer.

In some examples the termination configuration(s) may comprise a prioritization list of resources or measurement configurations. The UE may perform measurements according to the prioritization list. For example, the UE may perform measurements according to the highest priority measurement configuration and according to the limitation given in the termination configuration.

That is to say, the UE may perform measurements according to the highest priority measurement configuration until a limitation condition specified by the termination configuration is met (e.g. after finding no cell in carrier “z” is above a specified RSRP value for “x” seconds then measurements according to the highest priority validity measurement configuration stops). If the termination configuration indicates an overall time limit for the measurement configuration, and any other limitation condition(s) specified by the termination configuration is not met, the UE stops performing measurements according to the highest priority measurement configuration after the overall time limit expires.

When the termination condition associated with the highest priority measurement configuration is met, the UE may then perform measurements according to the next-highest priority measurement configuration in the remaining time before the overall time limit expires.

This process may be repeated for any number of measurement configurations in priority order indicated by the prioritization list, until the overall time limit expires.

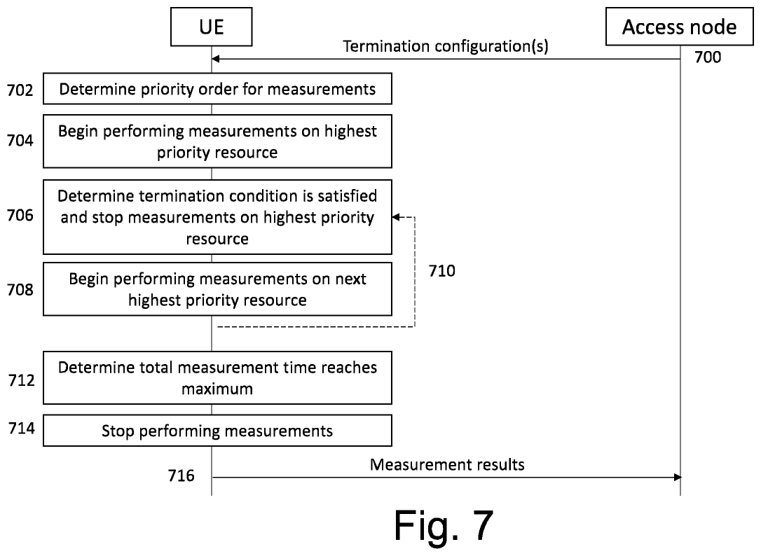

Reference is made to FIG. 7, which shows a signalling exchange according to some examples.

At 700, the network (e.g. an access node of the network) sends, to the UE, one or more termination configurations. The one or more termination configurations comprise one or more termination conditions associated with the termination of performance of one or more measurements.

The network may also send a prioritization list indicating a priority order for one or more measurement configurations. The network may send the validity termination configuration and/or the prioritization list in an RRC message (such as RRC Release) or as part of SIB.

At 702, when the network sends a prioritization list, the UE may determine a priority order of one or more measurement configurations for performing the one or more. The priority order may be determined based on a prioritization list received from the network in step 700.

At 704, the UE begins performing the one or more measurements. The UE may begin performing the measurements based on the determined priority order. For example, the UE may perform one or more measurements according to a first measurement configuration which has the highest priority. The UE may perform the one or more measurements based on a corresponding one or more measurement configurations. The one or more measurement configurations may be sent to the UE from the network, for example as part of or preceding step 700.

In some examples the UE may begin performing the one or more measurements based on a determination that a trigger condition is satisfied. In some examples the trigger condition may be one or more of:
that a certain cell X is measured as being above a RSRP threshold Y. The UE can then perform measurements on another cell (e.g. cell A)—as cell X can add cell A as part of dual connectivity/carrier aggregation, cell A may act as a secondary cell or PSCell for cell X;
the UE has entered a particular location (for example a location defined by a particular tracking area code or GPS co-ordinates);
a particular application or service has been initiated;
it is a specific time or time period. For example, when it is the evening the UE may need additional data due to streaming services or due to network load being decreased, and as such it may be beneficial to perform and report measurements for cells that support DCCA.

It should be understood that in some examples, trigger conditions other than those described above may be used.

At 706 the UE determines, based on the at least one termination configuration, that a termination condition associated with the first measurement configuration is satisfied. In response, the UE stops performing measurements according to the first measurement configuration.

The conditions may include but are not limited to those described above previously, for example: measurements on a given resource have been performed for a maximum time limit; or after not finding any cell in a carrier after a specified amount of time; or after finding no cell in a particular carrier above a specified RSRP value for a specified amount of time.

When the network has sent a prioritization list, at 708, the UE may determine, based on the determined priority order, to perform one or more measurements according to a next highest priority measurement configuration (i.e. a second measurement configuration), and starts performing one or more measurements according to the second measurement configuration.

As shown by dashed line 710 in FIG. 7, in some examples steps 706 and 708 may be repeated for any number of resources according to the prioritization list—i.e. for a third, fourth, fifth etc. measurement configuration and so on until step 712 is executed.

At 712, the UE determines that the total time spent performing measurements reaches or exceeds a total measurement time limit. The total measurement time limit may be received from the network, for example in the one or more termination configurations.

At 714, in response to determining that the total time spent performing measurements reaches or exceeds the total measurement time limit, the UE stops performing the one or more measurements according to all measurement configurations.

To illustrate steps 700-714 further, as an example: the UE receives termination configurations including a priority list for four different measurement configurations {A, B, C, D}, each of which indicates a different carrier (e.g. measurement configuration A indicates carrier A, measurement configuration B indicates carrier B, and so on), and a total measurement time limit of 10 seconds. The UE begins performing measurements according to measurement configuration A. After performing measurements for 3 seconds, the UE determines that no cell in carrier A is above a threshold RSRP value. In response, the UE stops performing measurements according to measurement configuration A, and begins performing measurements according to measurement configuration B. After performing measurements for 3 seconds, the UE determines that no cell in carrier B is above a threshold RSRP value. In response, the UE stops performing measurements according to measurement configuration B, and begins performing measurements according to measurement configuration C. The UE begins performing measurements according to measurement configuration C, and does so for 4 seconds, and finds that at least one cell in carrier C is above a threshold RSRP (and so does not terminate measurements early). After performing measurements according to measurement configuration C for 4 seconds, the UE determines that the total measurement time of 10 seconds has been reached (3 seconds measuring according to measurement configuration A, 3 seconds measuring according to measurement configuration B, and 4 seconds measuring according to measurement configuration C). The UE then stops performing all measurements (note that in this example no measurements are performed according to measurement configuration D as the total measurement time has reached the limit).

At 716 the UE may send the measurement results to the network.

In some examples the UE may indicate the availability of measurements to the network. For example, the UE may send, to the network, a message comprising information indicating that measurement results are available. The message may for example comprise an RRC message, such as an RRC Setup Complete or RRC Resume Complete message as described previously in relation to FIGS. 4 and 5.

In some examples, security keys may be exchanged between the UE and the network to establish a security context.

In some examples, the network may request the UE to provide the measurement results, and the UE may send the measurement results to the network based on the request.

Some examples may enhance UE performance while the UE is performing measurements, such as EMR related measurements. The UE may be configured to stop performing measurements when certain conditions are fulfilled. Some examples may therefore improve UE energy consumption.

In some examples, an apparatus may perform one or more of the steps described above. For example, an apparatus may comprise means for: receiving, from an access node, one or more termination configurations, the one or more termination configurations comprising one or more termination conditions associated with the termination of performance of one or more measurements; starting performing the one or more measurements according to a first measurement configuration; determining, based on the one or more measurements, that at least one termination condition associated with the first measurement configuration is satisfied; and terminating performance of the one or more measurements according to the first measurement configuration based on the determining.

In some examples the apparatus may comprise at least one processor and at least one memory storing instructions that, when executed by the at least one processor, cause the apparatus at least to: receive, from an access node, one or more termination configurations, the one or more termination configurations comprising one or more termination conditions associated with the termination of performance of one or more measurements; start performing the one or more measurements according to a first measurement configuration; determine, based on the one or more measurements, that at least one termination condition associated with the first measurement configuration is satisfied; and terminate performance of the one or more measurements according to the first measurement configuration based on the determining.

In some examples, an apparatus may comprise means for: sending, to a user equipment, one or more termination configurations, the one or more termination configurations comprising one or more termination conditions associated with the termination of performance of one or more measurements at the user equipment.

In some examples, the apparatus may comprise at least one processor and at least one memory storing instructions that, when executed by the at least one processor, cause the apparatus at least to: sending, to a user equipment, one or more termination configurations, the one or more termination configurations comprising one or more termination conditions associated with the termination of performance of one or more measurements at the user equipment.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1-19. (canceled)

20. An apparatus comprising:
a processor; and
a memory comprising computer-executable instructions that, when executed by the processor, cause the apparatus configured as a user equipment (UE) to perform the following operations:
receiving, while the UE is in a radio resource control (RRC) idle state or an RRC inactive state, from an access node via at least one of system information signaling or an RRC release message, one or more termination configurations, the one or more termination configurations comprising (i) a maximum per-carrier measurement time, (ii) a reference signal received power (RSRP) threshold, and (iii) an overall measurement time limit applicable across a plurality of measurement configurations, the termination configurations being associated with early measurement reporting (EMR) for dual connectivity or carrier aggregation;
starting performing the one or more measurements according to a first measurement configuration corresponding to a first carrier frequency identified in the termination configurations, the measurements comprising synchronization signal block (SSB) measurements performed while a legacy EMR timer remains active;
determining, based on the one or more measurements, that at least one termination condition associated with the first measurement configuration is satisfied, the termination condition comprising a determination that no cell on the first carrier frequency is measured above the RSRP threshold for a specified duration that is shorter than the legacy EMR timer; and
terminating performance of the one or more measurements according to the first measurement configuration prior to expiry of the legacy EMR timer and without transitioning the UE to an RRC connected state, thereby reducing UE energy consumption associated with continued measurements.

21. The apparatus of claim 20, wherein the operations further comprise:
receiving, from the access node, a prioritization list comprising a priority order of a plurality of measurement configurations for performing the one or more measurements, wherein the first measurement configuration corresponds to a measurement configuration having a highest priority in the prioritization list.

22. The apparatus of claim 21, wherein the operations further comprise:
responsive to terminating performance of the one or more measurements according to the first measurement configuration, starting performance of one or more measurements according to a second measurement configuration, the second measurement configuration having a next-highest priority relative to the first measurement configuration.

23. The apparatus of claim 22, wherein the operations further comprise:
determining that a termination condition associated with the second measurement configuration is satisfied, and terminating performance of the one or more measurements according to the second measurement configuration prior to expiry of the overall measurement time limit.

24. The apparatus of claim 23, wherein the operations further comprise:
determining that a total amount of time spent performing the one or more measurements across the plurality of measurement configurations reaches or exceeds a total measurement time limit; and
terminating performance of the one or more measurements according to all measurement configurations in response to the determining.

25. The apparatus of claim 24, wherein the operations further comprise:
receiving, from the access node, the total measurement time limit.

26. The apparatus of claim 25, wherein the total measurement time limit is included within the one or more termination configurations received from the access node.

27. The apparatus of claim 26, wherein the termination condition comprises:
measurements according to a given measurement configuration being performed for a maximum per-carrier time limit;
not detecting any cell on a carrier within a specified amount of time;
detecting no cell on a carrier having a measured signal value above a reference signal received power (RSRP) threshold for a specified duration;
the apparatus entering a predefined geographic or tracking area;
the apparatus entering or remaining in a predefined energy state;
termination of an application or service associated with triggering the measurements; and
a change of a camped cell of the apparatus.

28. The apparatus of claim 27, wherein the operations further comprise:
sending, to the access node, a radio resource control (RRC) message indicating availability of measurement results based on the one or more measurements.

29. The apparatus of claim 28, wherein the operations further comprise:
receiving, from the access node, a request for the measurement results after establishment of a security context; and
sending, to the access node, the measurement results in response to the request.

30. A method performed by an apparatus, the method comprising:
receiving, while the UE is in a radio resource control (RRC) idle state or an RRC inactive state, from an access node via at least one of system information signaling or an RRC release message, one or more termination configurations, the one or more termination configurations comprising (i) a maximum per-carrier measurement time, (ii) a reference signal received power (RSRP) threshold, and (iii) an overall measurement time limit applicable across a plurality of measurement configurations, the termination configurations being associated with early measurement reporting (EMR) for dual connectivity or carrier aggregation;
starting performing the one or more measurements according to a first measurement configuration corresponding to a first carrier frequency identified in the termination configurations, the measurements comprising synchronization signal block (SSB) measurements performed while a legacy EMR timer remains active;
determining, based on the one or more measurements, that at least one termination condition associated with the first measurement configuration is satisfied, the termination condition comprising a determination that no cell on the first carrier frequency is measured above the RSRP threshold for a specified duration that is shorter than the legacy EMR timer; and
terminating performance of the one or more measurements according to the first measurement configuration prior to expiry of the legacy EMR timer and without transitioning the UE to an RRC connected state, thereby reducing UE energy consumption associated with continued measurements.

31. The method of claim 30, further comprising:
receiving, from the access node, a prioritization list comprising a priority order of a plurality of measurement configurations for performing the one or more measurements, wherein the first measurement configuration corresponds to a measurement configuration having a highest priority in the prioritization list.

32. The method of claim 31, further comprising:
responsive to terminating performance of the one or more measurements according to the first measurement configuration, starting performance of one or more measurements according to a second measurement configuration, the second measurement configuration having a next-highest priority relative to the first measurement configuration.

33. The method of claim 32, further comprising:
determining that a termination condition associated with the second measurement configuration is satisfied, and terminating performance of the one or more measurements according to the second measurement configuration prior to expiry of the overall measurement time limit.

34. The method of claim 33, further comprising:
determining that a total amount of time spent performing the one or more measurements across the plurality of measurement configurations reaches or exceeds a total measurement time limit; and
terminating performance of the one or more measurements according to all measurement configurations in response to the determining.

35. The method of claim 34, further comprising:
receiving, from the access node, the total measurement time limit.

36. The method of claim 35, wherein the total measurement time limit is included within the one or more termination configurations received from the access node.

37. The method of claim 26, wherein the termination condition comprises:
measurements according to a given measurement configuration being performed for a maximum per-carrier time limit;
not detecting any cell on a carrier within a specified amount of time;
detecting no cell on a carrier having a measured signal value above a reference signal received power (RSRP) threshold for a specified duration;
the apparatus entering a predefined geographic or tracking area;
the apparatus entering or remaining in a predefined energy state;
termination of an application or service associated with triggering the measurements; and
a change of a camped cell of the apparatus.

38. The method of claim 37, further comprising:
sending, to the access node, a radio resource control (RRC) message indicating availability of measurement results based on the one or more measurements.

39. The method of claim 38, further comprising:
receiving, from the access node, a request for the measurement results after establishment of a security context; and
sending, to the access node, the measurement results in response to the request.
